(19) United States
(12) Patent Application Publication
(10) Pub. No.: US 2023/0413188 A1
(43) Pub. Date: Dec. 21, 2023

(54) PATH LOSS AND TRANSMIT POWER CALCULATION FOR A USER EQUIPMENT

(71) Applicant: QUALCOMM Incorporated, San Diego, CA (US)

(72) Inventors: Jeongho SEO, San Diego, CA (US); Simran KAUR, San Diego, CA (US); Hobin KIM, San Diego, CA (US); Rebecca Wen-Ling YUAN, San Diego, CA (US)

(21) Appl. No.: 17/808,032

(22) Filed: Jun. 21, 2022

(51) Int. Cl. H04W 52/24; H04W 52/32; H04L 5/00

(52) U.S. Cl. CPC H04W 52/245; H04W 52/325; H04W 52/242; H04L 5/0051

(57) ABSTRACT

A user equipment (UE) may obtain a plurality of reference signal received power (RSRP) measurements, each RSRP measurement of the plurality of RSRP measurements corresponding to an antenna port of a plurality of antenna ports associated with the UE. The UE may calculate a path loss and a transmit power for the plurality of antenna ports based on a worst RSRP measurement of the plurality of RSRP measurements, and may transmit a sounding reference signal (SRS) based on the transmit power. This may reduce a likelihood that a network node incorrectly estimates the channel conditions experienced by the UE and may improve the channel estimation capabilities of the network node.

### TECHNICAL FIELD

Aspects of the present disclosure relate generally to wireless communication and to techniques for a path loss and transmit power calculation for a user equipment.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (for example, a sidelink (SL), a wireless local area network (WLAN) link, or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method of wireless communication performed by an apparatus of a user equipment (UE). The method may include obtaining a plurality of reference signal received power (RSRP) measurements, each RSRP measurement of the plurality of RSRP measurements corresponding to an antenna port of a plurality of antenna ports associated with the UE; calculating a path loss and a transmit power for the plurality of antenna ports using a worst RSRP measurement of the plurality of RSRP measurements; and outputting a sounding reference signal (SRS) in accordance with the path loss and the transmit power.

In some implementations, calculating the path loss and the transmit power can include calculating the path loss and the transmit power for the plurality of antenna ports, and outputting the SRS may include outputting the SRS in accordance with the path loss and the transmit power.

In some implementations, calculating the path loss and the transmit power for the plurality of antenna ports may include calculating a common path loss or a common transmit power to be used by each antenna port of the plurality of antenna ports.

In some implementations, outputting the SRS in accordance with the path loss and the transmit power may include outputting a first SRS via a first antenna port of the plurality of antenna ports using the common transmit power; and outputting a second SRS via a second antenna port of the plurality of antenna ports using the common transmit power.

In some implementations, obtaining the plurality of RSRP measurements may include calculating the plurality of RSRP measurements based on one or more reference signals received from a network node.

In some implementations, the plurality of antenna ports may include a primary antenna port and one or more secondary antenna ports, and the worst RSRP measurement may correspond to a secondary antenna port of the one or more secondary antenna ports.

In some implementations, outputting the SRS may include outputting the SRS based on an antenna switching configuration of the UE.

Another innovative aspect of the subject matter described in this disclosure can be implemented in an apparatus of a UE for wireless communication. The apparatus may include one or more interfaces configured to obtain a plurality of RSRP measurements, each RSRP measurement of the plurality of RSRP measurements corresponding to an antenna port of a plurality of antenna ports associated with the UE. The apparatus may include a processing system configured to calculate a path loss and a transmit power for the plurality of antenna ports using a worst RSRP measurement of the plurality of RSRP measurements. The apparatus may include one or more interfaces configured to output an SRS in accordance with the path loss and the transmit power.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a UE, may cause the one or more processors to obtain a plurality of RSRP measurements, each RSRP measurement of the plurality of RSRP measurements corresponding to an antenna port of a plurality of antenna ports associated with the UE; calculate a path loss and a transmit power for the plurality of antenna ports using a worst RSRP measurement of the plurality of RSRP measurements; and output an SRS in accordance with the path loss and the transmit power

Another innovative aspect of the subject matter described in this disclosure can be implemented in an apparatus for wireless communication. The apparatus may include means for obtaining a plurality of RSRP measurements, each RSRP measurement of the plurality of RSRP measurements corresponding to an antenna port of a plurality of antenna ports associated with the UE; means for calculating a path loss and a transmit power for the plurality of antenna ports using a worst RSRP measurement of the plurality of RSRP measurements; and means for outputting an SRS in accordance with the path loss and the transmit power.

One innovative aspect of the subject matter described in this disclosure can be implemented in a method of wireless communication performed by an apparatus of a UE. The method may include obtaining a plurality of RSRP measurements, each RSRP measurement of the plurality of RSRP measurements corresponding to an antenna port of a plurality of antenna ports associated with the UE; calculating a path loss and a transmit power, for each antenna port of the plurality of antenna ports, using an RSRP measurement corresponding to each respective antenna port; and outputting an SRS via a select antenna port of the plurality of antenna ports in accordance with the path loss and the transmit power associated with the select antenna port.

In some implementations, the method may include outputting another SRS via another select antenna port of the plurality of antenna ports in accordance with the path loss and the transmit power associated with the other select antenna port.

In some implementations, calculating the path loss and the transmit power for each antenna port may include calculating the path loss and the transmit power for each antenna port, and outputting the SRS may include outputting the SRS via the select antenna port in accordance with the path loss and the transmit power associated with the select antenna port.

In some implementations, obtaining the plurality of RSRP measurements may include calculating the plurality of RSRP measurements based on one or more reference signals received from a network node.

In some implementations, the plurality of antenna ports may include a primary antenna port and one or more secondary antenna ports, and the select antenna port may be a secondary antenna port of the one or more secondary antenna ports.

In some implementations, outputting the SRS may include outputting the SRS based on an antenna switching configuration of the UE.

Another innovative aspect of the subject matter described in this disclosure can be implemented in an apparatus of a UE for wireless communication. The apparatus may include one or more interfaces configured to obtain a plurality of RSRP measurements, each RSRP measurement of the plurality of RSRP measurements corresponding to an antenna port of a plurality of antenna ports associated with the UE. The apparatus may include a processing system configured to calculate a path loss and a transmit power, for each antenna port of the plurality of antenna ports, using an RSRP measurement corresponding to each respective antenna port. The apparatus may include one or more interfaces configured to output an SRS via a select antenna port of the plurality of antenna ports in accordance with the transmit power associated with the select antenna port.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a UE, may cause the one or more processors to obtain a plurality of RSRP measurements, each RSRP measurement of the plurality of RSRP measurements corresponding to an antenna port of a plurality of antenna ports associated with the UE; calculate a path loss and a transmit power, for each antenna port of the plurality of antenna ports, using an RSRP measurement corresponding to each respective antenna port; and output an SRS via a select antenna port of the plurality of antenna ports in accordance with the transmit power associated with the select antenna port.

Another innovative aspect of the subject matter described in this disclosure can be implemented in an apparatus for wireless communication. The apparatus may include means for obtaining a plurality of RSRP measurements, each RSRP measurement of the plurality of RSRP measurements corresponding to an antenna port of a plurality of antenna ports associated with the UE; means for calculating a path loss and a transmit power, for each antenna port of the plurality of antenna ports, using an RSRP measurement corresponding to each respective antenna port; and means for outputting an SRS via a select antenna port of the plurality of antenna ports in accordance with the transmit power associated with the select antenna port.

Aspects generally include a method, apparatus, system, computer program product, non-transitory computer-readable medium, user equipment, base station, network entity, network node, wireless communication device, or processing system as substantially described herein with reference to and as illustrated by the accompanying drawings.

Details of one or more implementations of the subject matter described in this disclosure are set forth in the accompanying drawings and the description. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture.

FIG. 4 is a diagram illustrating an example of physical channels and reference signals in a wireless network.

FIG. 5 is a diagram illustrating an example of an antenna configuration.

FIG. 6 is a diagram illustrating an example of path loss and transmit power calculation for a UE.

FIG. 7 is a diagram illustrating an example process performed, for example, by a UE.

FIG. 8 is a diagram illustrating an example process performed, for example, by a UE.

FIG. 9 is a diagram of an example apparatus for wireless communication, in accordance with the present disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving radio frequency signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G technology, 4G technology, 5G technology, or further implementations thereof.

In some cases, a reference signal received power (RSRP) measurement associated with a first antenna port of a user equipment (UE) may be different than an RSRP measurement associated with a second antenna port of the UE. Therefore, a path loss and a transmit power for the first antenna port may be different than the path loss and the transmit power for the second antenna port, since the path loss and the transmit power may be calculated based on the respective RSRP measurements. This may result in incorrect channel estimation by a network node, which may negatively impact network performance such as by reducing data throughout. Using the techniques and apparatuses described herein, the UE may obtain a plurality of RSRP measurements, each RSRP measurement of the plurality of RSRP measurements corresponding to an antenna port of a plurality of antenna ports associated with the UE. In some aspects, the UE may calculate a path loss and a transmit power for the plurality of antenna ports based on a worst RSRP measurement of the plurality of RSRP measurements, and may transmit a sounding reference signal (SRS) based on the transmit power. In some aspects, the UE may calculate a path loss and a transmit power, for each antenna port of the plurality of antenna ports, based on an RSRP measurement corresponding to each respective antenna port, and may transmit an SRS via a select antenna port of the plurality of antenna ports based on the transmit power associated with the select antenna port. This may reduce a likelihood that a network node incorrectly estimates the channel conditions experienced by the UE and may improve the channel estimation capabilities of the network node.

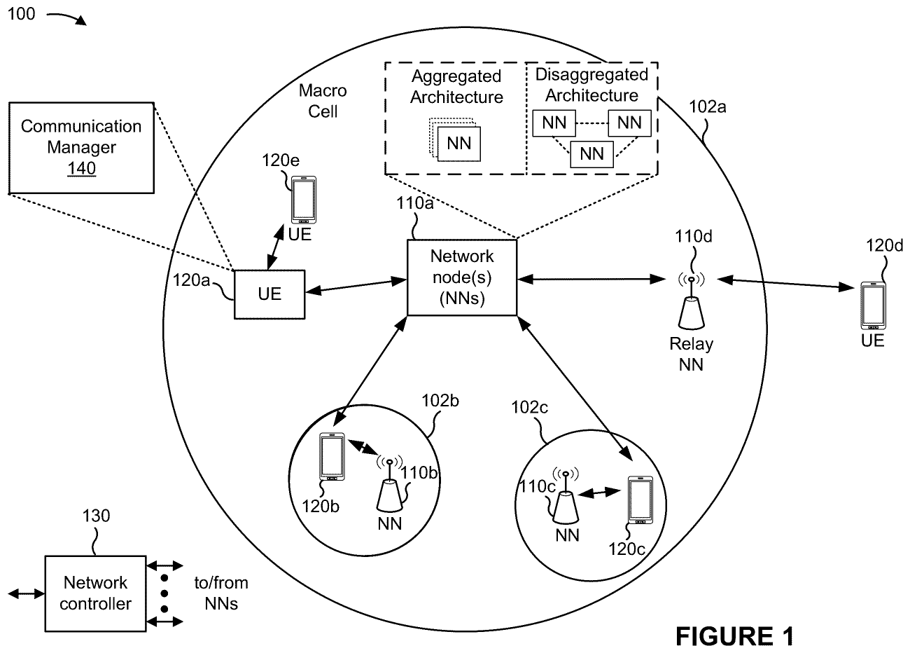

FIG. 1 is a diagram illustrating an example of a wireless network 100. The wireless network 100 may be or may include elements of a 5G (for example, NR) network or a 4G (for example, LTE) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (MC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may obtain a plurality of RSRP measurements, each RSRP measurement of the plurality of RSRP measurements corresponding to an antenna port of a plurality of antenna ports associated with the UE; calculate at least one of a path loss and a transmit power for the plurality of antenna ports using a worst RSRP measurement of the plurality of RSRP measurements; and transmit an SRS in accordance with the transmit power. Additionally, or alternatively, the communication manager 140 may perform one or more other operations described herein.

In some aspects, the communication manager 140 may obtain a plurality of RSRP measurements, each RSRP measurement of the plurality of RSRP measurements corresponding to an antenna port of a plurality of antenna ports associated with the UE; calculate a path loss and a transmit power, for each antenna port of the plurality of antenna ports, using an RSRP measurement corresponding to each respective antenna port; and transmit an SRS via a select antenna port of the plurality of antenna ports in accordance with the transmit power associated with the select antenna port. Additionally, or alternatively, the communication manager 140 may perform one or more other operations described herein.

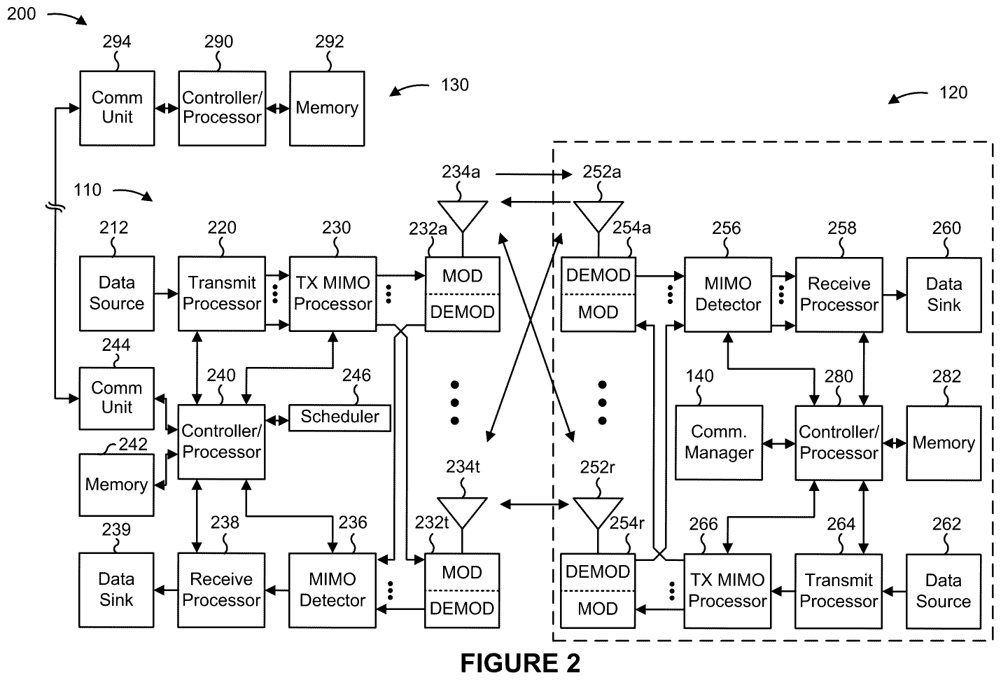

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

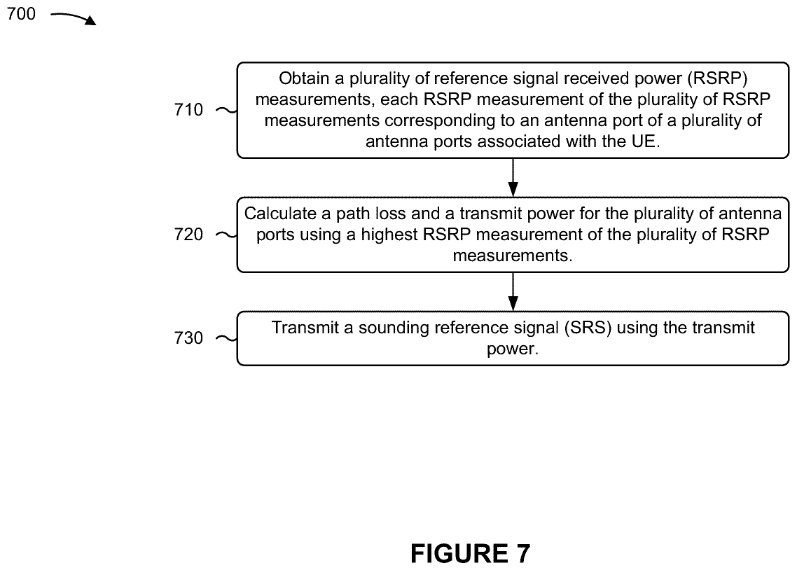

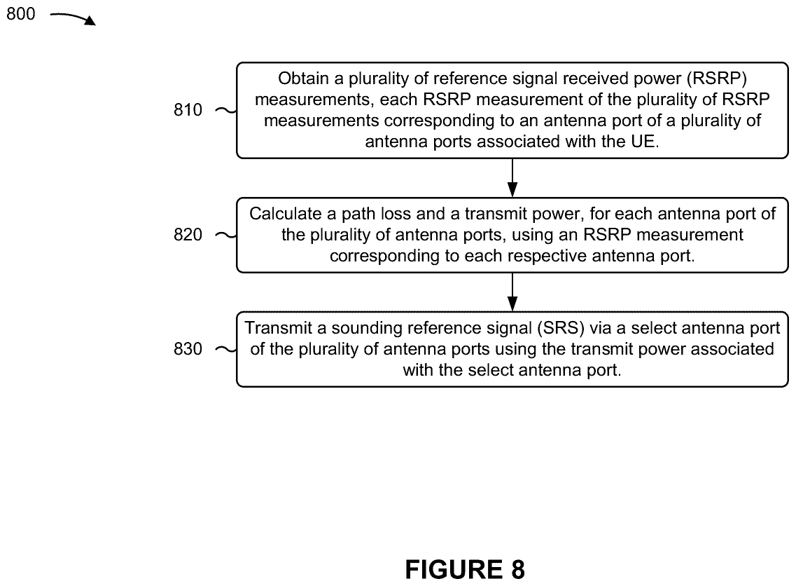

The controller/processor 240 of the network node 110, the controller/processor 280 of the UE 120, or any other component(s) of FIG. 2 may perform one or more techniques associated with a path loss and transmit power calculation for a UE, as described in more detail elsewhere herein. For example, the controller/processor 240 of the network node 110, the controller/processor 280 of the UE 120, or any other component(s) (or combinations of components) of FIG. 2 may perform or direct operations of, for example, process 700 of FIG. 7, process 800 of FIG. 8, or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, process 800 of FIG. 8, or other processes as described herein. In some examples, executing instructions may include running the instructions, converting the instructions, compiling the instructions, or interpreting the instructions.

In some aspects, the UE includes means for obtaining a plurality of RSRP measurements, each RSRP measurement of the plurality of RSRP measurements corresponding to an antenna port of a plurality of antenna ports associated with the UE; means for calculating a path loss and a transmit power for the plurality of antenna ports using a worst RSRP measurement of the plurality of RSRP measurements; or means for transmitting an SRS in accordance with the path loss and the transmit power. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for obtaining a plurality of RSRP measurements, each RSRP measurement of the plurality of RSRP measurements corresponding to an antenna port of a plurality of antenna ports associated with the UE; means for calculating a path loss and a transmit power, for each antenna port of the plurality of antenna ports, using an RSRP measurement corresponding to each respective antenna port; or means for transmitting an SRS via a select antenna port of the plurality of antenna ports in accordance with the path loss and the transmit power associated with the select antenna port. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described with respect to the blocks may be implemented in a single hardware, software, or combination component or in various combinations of components. For example, the functions described with respect to the transmit processor 264, the receive processor 258, the TX MIMO processor 266, or another processor may be performed by or under the control of the controller/processor 280.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

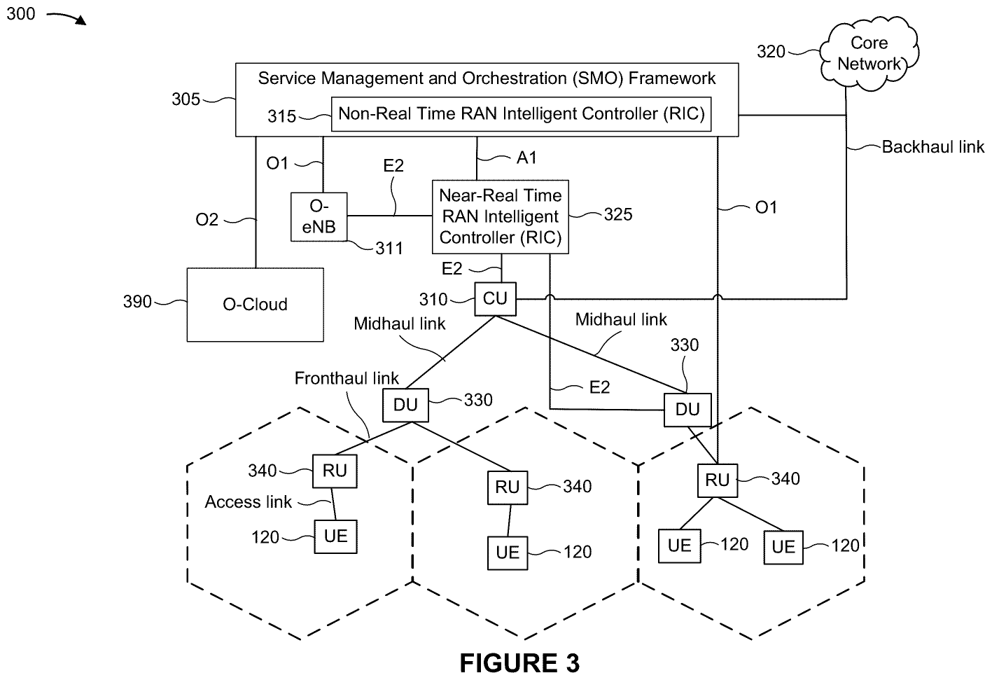

FIG. 3 is a diagram illustrating an example disaggregated base station architecture 300. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the non-RT RIC 315 or the Near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

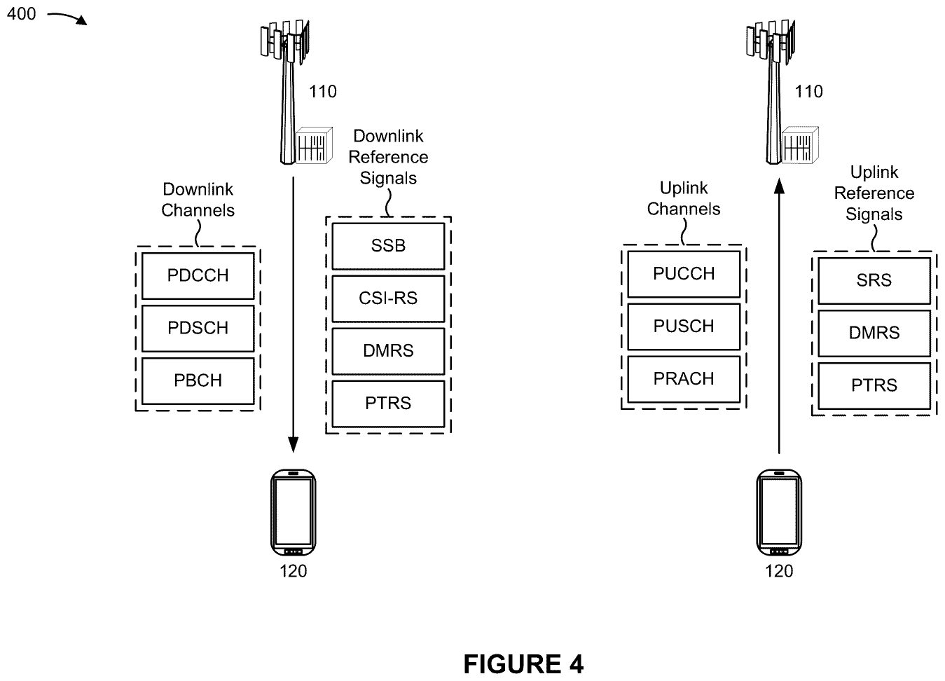

FIG. 4 is a diagram illustrating an example 400 of physical channels and reference signals in a wireless network. As shown in FIG. 4, downlink channels and downlink reference signals may carry information from a network node 110 to a UE 120, and uplink channels and uplink reference signals may carry information from a UE 120 to a network node 110.

As shown, a downlink (DL) channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink (UL) channel may include a physical uplink control channel (PUCCH) that carries uplink control information (UCI), a physical uplink shared channel (PUSCH) that carries uplink data, or a PRACH used for initial network access, among other examples. In some aspects, the UE 120 may transmit acknowledgement (ACK) or negative acknowledgement (NACK) feedback (for example, ACK/NACK feedback or ACK/NACK information) in UCI on the PUCCH or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (for example, downlink CSI acquisition), which may be used for scheduling, link adaptation, or beam management, among other examples. The network node 110 may configure a set of CSI-RSs for the UE 120, and the UE 120 may measure the configured set of CSI-RSs. Based on the measurements, the UE 120 may perform channel estimation and may report channel estimation parameters to the network node 110 (for example, in a CSI report), such as a CQI, a precoding matrix indicator (PMI), a CSI-RS resource indicator (CRI), a layer indicator (LI), a rank indicator (RI), or an RSRP, among other examples. The network node 110 may use the CSI report to select transmission parameters for downlink communications to the UE 120, such as a number of transmission layers (for example, a rank), a precoding matrix (for example, a precoder), a n MCS, or a refined downlink beam (for example, using a beam refinement procedure or a beam management procedure), among other examples.

A DMRS may carry information used to estimate a radio channel for demodulation of an associated physical channel (for example, PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (for example, rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (for example, on the PDSCH) and uplink communications (for example, on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (for example, a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (for example, a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based on the measurements, and may use the SRS measurements to configure communications with the UE 120.

As indicated herein, FIG. 4 is provided as an example. Other examples may differ from what is described with regard to FIG. 4.

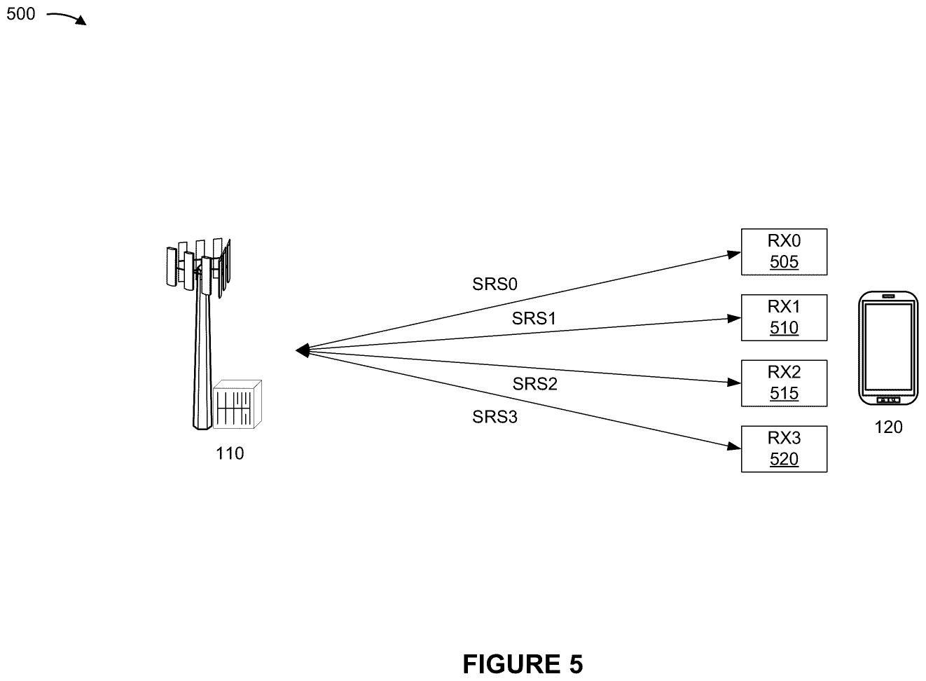

FIG. 5 is a diagram illustrating an example 500 of an antenna configuration. In some cases, as described herein, the UE 120 may calculate an RSRP based on signaling from the network node 110. For example, the network node 110 may transmit a downlink reference signal, such as a CSI-RS or an SSB, and the UE 120 may calculate the RSRP based on the downlink reference signal. Additionally, or alternatively, the UE 120 may calculate a path loss and a transmit power for one or more antennas of the UE 120 based on the downlink reference signal. In some cases, the UE 120 may transmit an uplink reference signal, such as an SRS, based on the calculated path loss and transmit power. The transmission of the SRS based on the transmit power may enable the network node 110 to perform additional measurements or to perform channel estimation.

In some cases, the UE 120 may be configured with a plurality of antenna ports. Each of the plurality of antenna ports may correspond to an antenna associated with the UE 120. In some cases, antenna switching may enable uplink transmit diversity when the UE 120 is equipped with at least two antennas and a set of transmit chains that is a subset of a set of the receive chains. For example, antenna switching may enable uplink transmit diversity when the UE 120 is equipped with four antennas and either one or two transmit chains that is a subset of the four receive chains. In some cases, a transmit switch, which connects a power amplifier output signal to one of the antenna ports of the UE 120, may facilitate time switch transmit diversity (TSTD) or selection transmit diversity (STD). TSTD may enable delivery of the uplink reference signals alternately through the antennas, while STD may enable delivery of the uplink reference signals through a best antenna, such as a best antenna selected by the network node 110.

As shown in the example 500, the UE 120 may include four receiver antennas, each of the receiver antennas being associated with a receiver antenna port. For example, the UE 120 may be associated with a first antenna port 505 (shown as Rx0), a second antenna port 510 (shown as Rx1), a third antenna port 515 (shown as Rx2), and a fourth antenna port 520 (shown as Rx3). The UE 120 may be configured to perform antenna switching between the plurality of antenna ports, as described herein. In some cases, the RSRP measurements may be different for one or more of the antenna ports. For example, the first antenna port 505 may be associated with a first RSRP measurement and the second antenna port 510 may be associated with a second RSRP measurement that is different than the first RSRP measurement. This may be referred to as an RSRP imbalance between the antenna ports. In some cases, the UE 120 may calculate a path loss and a transmit power for an antenna port based on the RSRP measurement associated with the antenna port. The UE 120 may transmit an SRS based on the transmit power. For example, the UE 120 may transmit an SRS0 corresponding to the first antenna port 505, an SRS1 corresponding to the second antenna port 510, an SRS2 corresponding to the third antenna port 515, or an SRS3 corresponding to the fourth antenna port 520. In some cases, the path loss and the transmit power for the respective antenna ports may be different based on the different RSRP measurements for the antenna ports. For example, the path loss and the transmit power for the first antenna port 505 may be different than the path loss and the transmit power for the second antenna port 510 based on the first antenna port 505 and the second antenna port 510 having the different RSRP measurements.

In some cases, the UE 120 may calculate the path loss and the transmit power for the UE 120 based on a particular antenna port. For example, the UE 120 may calculate the path loss and the transmit power to be used by all of the antenna ports associated with the UE 120 based on a default antenna port (for example, a primary antenna port), such as the first antenna port 505. However, in some cases, the RSRP associated with the first antenna port 505 may be better (for example, higher) than the RSRP associated with the other antenna ports. In this case, the network node 110 may estimate that the channel conditions experienced by the UE 120 are better than the actual channel conditions. Alternatively, in some cases, the RSRP associated with the first antenna port 505 may be worse (for example, lower) than the RSRP associated with the other antenna ports. In this case, the network node 110 may estimate that the channel conditions experienced by the UE 120 are worse than the actual channel conditions. This may result in incorrect measurements or incorrect channel estimation by the network node 110, which may negatively impact network performance such as by reducing data throughout.

Techniques and apparatuses are described herein for path loss and transmit power calculation for a UE. A UE (such as the UE 120) may obtain a plurality of RSRP measurements, each RSRP measurement of the plurality of RSRP measurements corresponding to an antenna port of a plurality of antenna ports associated with the UE. In some aspects, the UE may calculate a path loss and a transmit power for the plurality of antenna ports based on a worst RSRP measurement of the plurality of RSRP measurements, and may transmit an SRS based on the transmit power. In some aspects, the UE may calculate a path loss and a transmit power, for each antenna port of the plurality of antenna ports, based on an RSRP measurement corresponding to each respective antenna port, and may transmit an SRS via a select antenna port of the plurality of antenna ports based on the transmit power associated with the select antenna port.

As described herein, an RSRP measurement associated with a first antenna port of the UE may be different than an RSRP measurement associated with a second antenna port of the UE. In some cases, the path loss and the transmit power for the first antenna port may be different than the path loss and the transmit power for the second antenna port, since the path loss and the transmit power may be calculated based on the respective RSRP measurements. This may result in incorrect channel estimation by the network node, which may negatively impact network performance such as by reducing data throughout. Using the techniques and apparatuses described herein, the UE may calculate the path loss and the transmit power based on a worst RSRP measurement of the plurality of antenna ports, or may calculate the path loss and the transmit power individually for each of the plurality of antenna ports. This may reduce the likelihood that the network node over-estimates (or under-estimates) the channel conditions experienced by the antenna ports of the UE, and therefore, may improve the channel estimation capabilities of the network node.

As indicated herein, FIG. 5 is provided as an example. Other examples may differ from what is described with regard to FIG. 5.

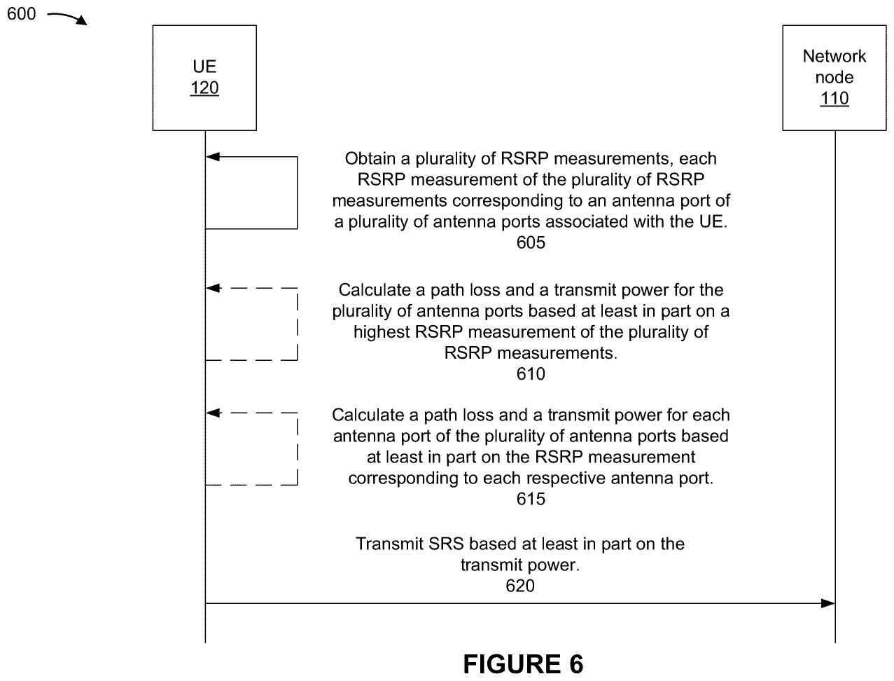

FIG. 6 is a diagram illustrating an example 600 of path loss and transmit power calculation for a UE. A UE, such as the UE 120, may communicate with a network node, such as the network node 110. The network node 110 may include some or all of the features of the CU 310, the DU 330, or the RU 340 described herein.

As shown in connection with reference number 605, the UE 120 may obtain a plurality of RSRP measurements. Each of the plurality of RSRP measurements may correspond to an antenna port of a plurality of antenna ports associated with the UE 120. In some aspects, obtaining the plurality of RSRP measurements may include calculating the plurality of RSRP measurements. For example, the UE 120 may receive one or more downlink reference signals from the network node 110, and may calculate the RSRP measurements for the antenna ports based on the one or more downlink reference signals.

In some aspects, the UE 120 may be configured with a plurality of antenna ports, and each of the plurality of antenna ports may correspond to an antenna of the UE 120. In an example antenna port configuration, the UE 120 may be configured with four antenna ports, such as a first antenna port, a second antenna port, a third antenna port, and a fourth antenna port. As described herein, the UE 120 may be configured to perform antenna switching between the plurality of antenna ports. In some aspects, an RSRP measurement associated with one of the antenna ports may be different than an RSRP measurement associated with another one of the antenna ports. For example, an RSRP measurement associated with the first antenna port may be different than an RSRP measurement associated with the second antenna port. As described herein, this may result in the network node 110 being unable to properly (for example, accurately) estimate the channel conditions.

In one example, an RSRP measurement associated with the first antenna port (for example, the antenna port of the plurality of antenna ports that is associated with the lowest RSRP measurement) may be different than an RSRP measurement associated with the second antenna port (for example, the antenna port of the plurality of antenna ports that is associated with the worst RSRP measurement) by a certain value. For example, the first antenna port may have an RSRP measurement of −84 decibel-milliwatts (dBm), the second antenna port may have an RSRP measurement of −100 dBm, the third antenna port may have an RSRP measurement of −89 dBm, and the fourth antenna port may have an RSRP measurement of −96 dBm. In this case, the RSRP imbalance between the plurality of antenna ports may be 16 dBm. As shown in Table 1 herein, this may negatively impact network performance. For example, the network throughput without the RSRP imbalance may be 994,443.408 kilobits per second (Kbps), while the network throughput with the RSRP imbalance of 16 dBm may be 503,602.457 Kbps. In some aspects, an average (Avg) value, a minimum (min) value, a maximum (max) value, or a standard deviation (Stdev) may be calculated for one or more of the PDSCH parameters shown in Table 1.

TABLE 1
Channel conditions with or without RSRP imbalance

| | Without RSRP | With RSRP |
|---|---|---|
| | imbalance with | imbalance with |
| | best chain as Rx0 | best chain as Rx0 |
| Physical layer throughput (over DL | 994443.408 | 503602.457 |
| grant slots) in Kbps | | |
| PDSCH scheduling rate (%) | 76.888 | 69.226 |
| PDSCH first transmission block | 8.014 | 9.984 |
| error rate (BLER) (%) | | |
| PDSCH BLER (%) | 7.421 | 9.099 |
| PDSCH residual BLER (%) | 0.000 | 0.011 |
| DL MCS (Avg/Min/Max/Stdev) | 23.003/16/ | 14.459/0/ |
| | 273/17.637 | 16/1.112 |
| DL resource blocks (RBs) | 263.526/16/ | 262.123/16/ |
| (Avg/Min/Max/Stdev) | 273/17.637 | 273/22.611 |
| Num DL Layers | 2.503/1/4/0.637 | 2.000/1/2/0.010 |
| (Avg/Min/Max/Stdev) | | |
| PDSCH transport block (TB) size | 67522.699/60/ | 34731.553/42/ |
| (Avg/Min/Max/Stdev) | 98321/12369.882 | 43047/6105.994 |

In some aspects, as shown in connection with reference number 610, the UE 120 may calculate a path loss and a transmit power for the plurality of antenna ports based on a worst RSRP measurement of the plurality of RSRP measurements. For example, the UE 120 may calculate the path loss and the transmit power for the plurality of antenna ports based on the worst RSRP measurement of the plurality of RSRP measurements, which in some examples, may be the lowest RSRP measurement of the plurality of RSRP measurements. As described in the example herein, the first antenna port may have an RSRP measurement of −84 dBm, the second antenna port may have an RSRP measurement of −100 dBm, the third antenna port may have an RSRP measurement of −89 dBm, and the fourth antenna port may have an RSRP measurement of −96 dBm. In this example, the UE 120 may calculate the path loss and the transmit power to be used by all of the antenna ports, of the plurality of antenna ports, based on the worst RSRP measurement (for example, −100 dBm) of the plurality of RSRP measurements. In some aspects, the UE 120 may calculate a common path loss and a common transmit power based on the worst RSRP measurement, and may apply the common transmit power to transmissions by each of the plurality of antenna ports, such as the first antenna port, the second antenna port, the third antenna port, and the fourth antenna port.

In some aspects, as shown in connection with reference number 615, the UE 120 may calculate a path loss and a transmit power, for each antenna port of the plurality of antenna ports, based on an RSRP measurement corresponding to each respective antenna port. In this case, the UE 120 may calculate the path loss and the transmit power for each individual antenna port based on the RSRP measurement corresponding to that antenna port. For example, the UE 120 may calculate a path loss and a transmit power for the first antenna port based on the RSRP measurement of −84 dBm corresponding to the first antenna port, may calculate a path loss and a transmit power for the second antenna port based on the RSRP measurement of −100 dBm corresponding to the second antenna port, may calculate a path loss and a transmit power for the third antenna port based on the RSRP measurement of −89 dBm corresponding to the third antenna port, and may calculate a path loss and a transmit power for the fourth antenna port based on the RSRP measurement of −96 dBm corresponding to the fourth antenna port. The UE 120 may apply the transmit power to an antenna port of the plurality of antenna ports based on calculating the path loss and the transmit power for the antenna port using the RSRP measurement corresponding to that antenna port.

As shown in connection with reference number 620, the UE 120 may transmit an SRS based on the transmit power. In some aspects, the UE 120 may transmit the SRS via any of the antenna ports using the transmit power that is based on the worst RSRP measurement associated with the plurality of antenna ports. For example, the UE 120 may calculate the common path loss and the common transmit power based on the worst RSRP measurement corresponding to the first antenna port, the second antenna port, the third antenna port, or the fourth antenna port, and may transmit the SRS via the first antenna port, the second antenna port, the third antenna port, or the fourth antenna port using the common transmit power. In some aspects, the UE 120 may transmit the SRS via a select antenna port based on the transmit power calculated using the RSRP measurement associated with the select antenna port. For example, the UE 120 may transmit the SRS via the first antenna port using the transmit power that is based on the RSRP associated with the first antenna port, may transmit the SRS via the second antenna port using the transmit power that is based on the RSRP associated with the second antenna port, may transmit the SRS via the third antenna port using the transmit power that is based on the RSRP associated with the third antenna port, or may transmit the SRS via the fourth antenna port using the transmit power that is based on the RSRP associated with the fourth antenna port.

As described herein, an RSRP measurement associated with a first antenna port of the UE 120 may be different than an RSRP measurement associated with a second antenna port of the UE 120. In some cases, the path loss and the transmit power for the first antenna port may be different than the path loss and the transmit power for the second antenna port, since the path loss and the transmit power may be calculated based on the respective RSRP measurements. This may result in incorrect channel estimation by the network node 110, which may negatively impact network performance such as by reducing data throughout. Using the techniques and apparatuses described herein, the UE 120 may calculate the path loss and the transmit power based on a worst RSRP measurement of the plurality of antenna ports, or may calculate the path loss and the transmit power individually for each of the plurality of antenna ports. This may reduce the likelihood that the network node 110 over-estimates (or under-estimates) the channel conditions experienced by the antenna ports of the UE 120, and therefore, may improve the channel estimation capabilities of the network node 110.

As indicated herein, FIG. 6 is provided as an example. Other examples may differ from what is described with regard to FIG. 6.

FIG. 7 is a diagram illustrating an example process 700 performed, for example, by a UE. The process 700 is an example where the UE (for example, UE 120) performs operations associated with path loss and transmit power calculation for a UE.

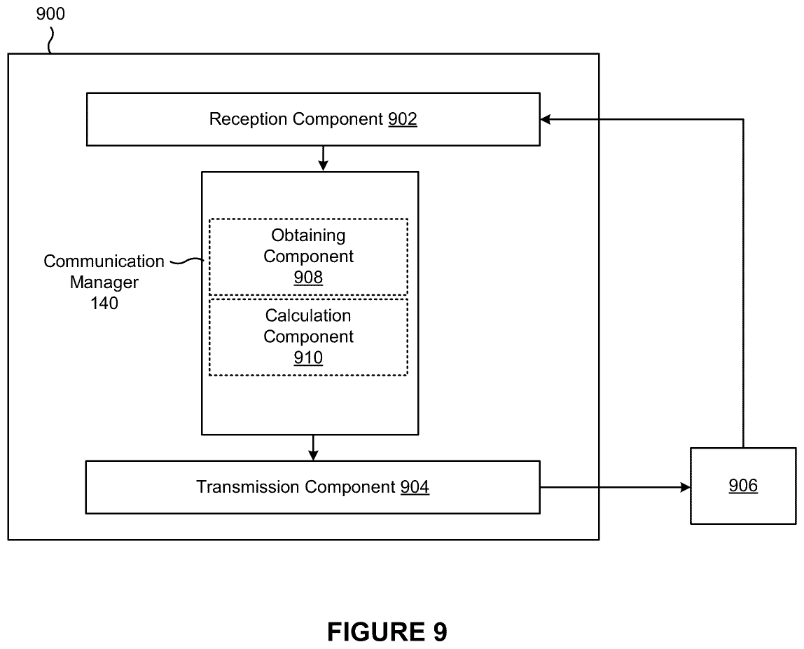

As shown in FIG. 7, in some aspects, the process 700 may include obtaining a plurality of RSRP measurements, each RSRP measurement of the plurality of RSRP measurements corresponding to an antenna port of a plurality of antenna ports associated with the UE (block 710). For example, the UE (such as by using communication manager 140 or obtaining component 908, depicted in FIG. 9) may obtain a plurality of RSRP measurements, each RSRP measurement of the plurality of RSRP measurements corresponding to an antenna port of a plurality of antenna ports associated with the UE.

As further shown in FIG. 7, in some aspects, the process 700 may include calculating a path loss and a transmit power for the plurality of antenna ports using a worst RSRP measurement of the plurality of RSRP measurements (block 720). For example, the UE (such as by using communication manager 140 or calculation component 910, depicted in FIG. 9) may calculate a path loss and a transmit power for the plurality of antenna ports using a worst RSRP measurement of the plurality of RSRP measurements.

As further shown in FIG. 7, in some aspects, the process 700 may include transmitting an SRS in accordance with the path loss and the transmit power (block 730). For example, the UE (such as by using communication manager 140 or transmission component 904, depicted in FIG. 9) may transmit an SRS in accordance with the transmit power.

The process 700 may include additional aspects, such as any single aspect or any combination of aspects described in connection with the process 700 or in connection with one or more other processes described elsewhere herein.

In a first additional aspect, calculating the path loss and the transmit power includes calculating the path loss and the transmit power for the plurality of antenna ports, and where transmitting the SRS includes transmitting the SRS in accordance with the transmit power.

In a second additional aspect, alone or in combination with the first aspect, calculating the path loss and the transmit power for the plurality of antenna ports includes calculating a common path loss and a common transmit power to be used by each antenna port of the plurality of antenna ports.

In a third additional aspect, alone or in combination with one or more of the first and second aspects, transmitting the SRS in accordance with the transmit power includes transmitting a first SRS via a first antenna port of the plurality of antenna ports using the common transmit power, and transmitting a second SRS via a second antenna port of the plurality of antenna ports using the common transmit power.

In a fourth additional aspect, alone or in combination with one or more of the first through third aspects, obtaining the plurality of RSRP measurements includes calculating the plurality of RSRP measurements based on one or more reference signals received from a network node.

In a fifth additional aspect, alone or in combination with one or more of the first through fourth aspects, each RSRP measurement of the plurality of RSRP measurements corresponds to a dBm value, and the worst RSRP measurement is an RSRP measurement of the plurality of RSRP measurements having a lowest dBm value.

In a sixth additional aspect, alone or in combination with one or more of the first through fifth aspects, the plurality of antenna ports includes a primary antenna port and one or more secondary antenna ports, and the worst RSRP measurement corresponds to a secondary antenna port of the one or more secondary antenna ports.

In a seventh additional aspect, alone or in combination with one or more of the first through sixth aspects, each RSRP measurement of the plurality of RSRP measurements has a different RSRP measurement value.

In an eighth additional aspect, alone or in combination with one or more of the first through seventh aspects, transmitting the SRS includes transmitting the SRS based on an antenna switching configuration of the UE.

In a ninth additional aspect, alone or in combination with one or more of the first through eighth aspects, the plurality of antenna ports is four antenna ports.

Although FIG. 7 shows example blocks of the process 700, in some aspects, the process 700 may include additional blocks, fewer blocks, different blocks, or differently arranged blocks than those depicted in FIG. 7. Additionally, or alternatively, two or more of the blocks of the process 700 may be performed in parallel.

FIG. 8 is a diagram illustrating an example process 800 performed, for example, by a UE. The process 800 is an example where the UE (for example, UE 120) performs operations associated with path loss and transmit power calculation for a UE.

As shown in FIG. 8, in some aspects, the process 800 may include obtaining a plurality of RSRP measurements, each RSRP measurement of the plurality of RSRP measurements corresponding to an antenna port of a plurality of antenna ports associated with the UE (block 810). For example, the UE (such as by using communication manager 140 or obtaining component 908, depicted in FIG. 9) may obtain a plurality of RSRP measurements, each RSRP measurement of the plurality of RSRP measurements corresponding to an antenna port of a plurality of antenna ports associated with the UE.

As further shown in FIG. 8, in some aspects, the process 800 may include calculating a path loss and a transmit power, for each antenna port of the plurality of antenna ports, using an RSRP measurement corresponding to each respective antenna port (block 820). For example, the UE (such as by using communication manager 140 or calculation component 910, depicted in FIG. 9) may calculate a path loss and a transmit power, for each antenna port of the plurality of antenna ports, using an RSRP measurement corresponding to each respective antenna port.

As further shown in FIG. 8, in some aspects, the process 800 may include transmitting an SRS via a select antenna port of the plurality of antenna ports in accordance with the transmit power associated with the select antenna port (block 830). For example, the UE (such as by using communication manager 140 or transmission component 904, depicted in FIG. 9) may transmit an SRS via a select antenna port of the plurality of antenna ports in accordance with the transmit power associated with the select antenna port.

The process 800 may include additional aspects, such as any single aspect or any combination of aspects described in connection with the process 800 or in connection with one or more other processes described elsewhere herein.

In a first additional aspect, the process 800 includes transmitting another SRS via another select antenna port of the plurality of antenna ports in accordance with the transmit power associated with the other select antenna port.

In a second additional aspect, alone or in combination with the first aspect, calculating the path loss and the transmit power for each antenna port includes calculating the path loss and the transmit power for each antenna port, and where transmitting the SRS includes transmitting the SRS via the select antenna port in accordance with the transmit power associated with the select antenna port.

In a third additional aspect, alone or in combination with one or more of the first and second aspects, obtaining the plurality of RSRP measurements includes calculating the plurality of RSRP measurements based on one or more reference signals received from a network node.

In a fourth additional aspect, alone or in combination with one or more of the first through third aspects, the plurality of antenna ports includes a primary antenna port and one or more secondary antenna ports, and the select antenna port is a secondary antenna port of the one or more secondary antenna ports.

In a fifth additional aspect, alone or in combination with one or more of the first through fourth aspects, each RSRP measurement of the plurality of RSRP measurements has a different RSRP measurement value.

In a sixth additional aspect, alone or in combination with one or more of the first through fifth aspects, transmitting the SRS includes transmitting the SRS based on an antenna switching configuration of the UE.

In a seventh additional aspect, alone or in combination with one or more of the first through sixth aspects, the plurality of antenna ports is four antenna ports.

Although FIG. 8 shows example blocks of the process 800, in some aspects, the process 800 may include additional blocks, fewer blocks, different blocks, or differently arranged blocks than those depicted in FIG. 8. Additionally, or alternatively, two or more of the blocks of the process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of an obtaining component 908 or a calculation component 910, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7, process 800 of FIG. 8, or a combination thereof. In some aspects, the apparatus 900 or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The obtaining component 908 may obtain a plurality of RSRP measurements, each RSRP measurement of the plurality of RSRP measurements corresponding to an antenna port of a plurality of antenna ports associated with the UE. The calculation component 910 may calculate a path loss and a transmit power for the plurality of antenna ports using a worst RSRP measurement of the plurality of RSRP measurements. The transmission component 904 may transmit an SRS in accordance with the path loss and the transmit power.

The obtaining component 908 may obtain a plurality of RSRP measurements, each RSRP measurement of the plurality of RSRP measurements corresponding to an antenna port of a plurality of antenna ports associated with the UE. The calculation component 910 may calculate a path loss and a transmit power, for each antenna port of the plurality of antenna ports, using an RSRP measurement corresponding to each respective antenna port. The transmission component 904 may transmit an SRS via a select antenna port of the plurality of antenna ports in accordance with the path loss and the transmit power associated with the select antenna port. The transmission component 904 may transmit another SRS via another select antenna port of the plurality of antenna ports in accordance with the transmit power associated with the other select antenna port.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components.

Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: obtaining a plurality of reference signal received power (RSRP) measurements, each RSRP measurement of the plurality of RSRP measurements corresponding to an antenna port of a plurality of antenna ports associated with the UE; calculating a path loss and a transmit power for the plurality of antenna ports using a worst RSRP measurement of the plurality of RSRP measurements; and transmitting a sounding reference signal (SRS) using the transmit power.
Aspect 2: The method of Aspect 1, wherein calculating the path loss and the transmit power for the plurality of antenna ports comprises calculating a common path loss and a common transmit power to be used by each antenna port of the plurality of antenna ports.
Aspect 3: The method of Aspect 2, wherein transmitting the SRS using the path loss and the transmit power comprises: transmitting a first SRS via a first antenna port of the plurality of antenna ports using the common transmit power; and transmitting a second SRS via a second antenna port of the plurality of antenna ports using the common transmit power.
Aspect 4: The method of any of Aspects 1-3, wherein obtaining the plurality of RSRP measurements comprises calculating the plurality of RSRP measurements using one or more reference signals received from a network node.
Aspect 5: The method of any of Aspects 1-4, wherein the plurality of antenna ports includes a primary antenna port and one or more secondary antenna ports, and the worst RSRP measurement corresponds to a secondary antenna port of the one or more secondary antenna ports.
Aspect 6: The method of any of Aspects 1-5, wherein each RSRP measurement of the plurality of RSRP measurements has a different RSRP measurement value.
Aspect 7: The method of any of Aspects 1-6, wherein the worst RSRP measurement is a lowest RSRP measurement of the plurality of RSRP measurements.
Aspect 8: The method of any of Aspects 1-7, wherein transmitting the SRS comprises transmitting the SRS in accordance with an antenna switching configuration of the UE.
Aspect 9: The method of any of Aspects 1-8, wherein the plurality of antenna ports is four antenna ports.
Aspect 10: A method of wireless communication performed by a user equipment (UE), comprising: obtaining a plurality of reference signal received power (RSRP) measurements, each RSRP measurement of the plurality of RSRP measurements corresponding to an antenna port of a plurality of antenna ports associated with the UE; calculating a path loss and a transmit power, for each antenna port of the plurality of antenna ports, using an RSRP measurement corresponding to each respective antenna port; and transmitting a sounding reference signal (SRS) via a select antenna port of the plurality of antenna ports using the transmit power associated with the select antenna port.
Aspect 11: The method of Aspect 10, further comprising transmitting another SRS via another select antenna port of the plurality of antenna ports using the transmit power associated with the other select antenna port.
Aspect 12: The method of any of Aspects 10-11, wherein obtaining the plurality of RSRP measurements comprises calculating the plurality of RSRP measurements using one or more reference signals received from a network node.
Aspect 13: The method of any of Aspects 10-12, wherein the plurality of antenna ports includes a primary antenna port and one or more secondary antenna ports, and the select antenna port is a secondary antenna port of the one or more secondary antenna ports.
Aspect 14: The method of any of Aspects 10-13, wherein each RSRP measurement of the plurality of RSRP measurements has a different RSRP measurement value.
Aspect 15: The method of any of Aspects 10-14, wherein transmitting the SRS comprises transmitting the SRS in accordance with an antenna switching configuration of the UE.
Aspect 16: The method of any of Aspects 10-15, wherein the plurality of antenna ports is four antenna ports.
Aspect 17: An apparatus for wireless communication at a device, comprising a processor; memory coupled with the processor; and instructions stored in the memory and executable by the processor to cause the apparatus to perform the method of one or more of Aspects 1-9.
Aspect 18: A device for wireless communication, comprising a memory and one or more processors coupled to the memory, the one or more processors configured to perform the method of one or more of Aspects 1-9.
Aspect 19: An apparatus for wireless communication, comprising at least one means for performing the method of one or more of Aspects 1-9.
Aspect 20: A non-transitory computer-readable medium storing code for wireless communication, the code comprising instructions executable by a processor to perform the method of one or more of Aspects 1-9.
Aspect 21: A non-transitory computer-readable medium storing a set of instructions for wireless communication, the set of instructions comprising one or more instructions that, when executed by one or more processors of a device, cause the device to perform the method of one or more of Aspects 1-9.
Aspect 22: An apparatus for wireless communication at a device, comprising a processor; memory coupled with the processor; and instructions stored in the memory and executable by the processor to cause the apparatus to perform the method of one or more of Aspects 10-16.
Aspect 23: A device for wireless communication, comprising a memory and one or more processors coupled to the memory, the one or more processors configured to perform the method of one or more of Aspects 10-16.
Aspect 24: An apparatus for wireless communication, comprising at least one means for performing the method of one or more of Aspects 10-16.
Aspect 25: A non-transitory computer-readable medium storing code for wireless communication, the code comprising instructions executable by a processor to perform the method of one or more of Aspects 10-16.
Aspect 26: A non-transitory computer-readable medium storing a set of instructions for wireless communication, the set of instructions comprising one or more instructions that, when executed by one or more processors of a device, cause the device to perform the method of one or more of Aspects 10-16.

The foregoing disclosure provides illustration and description but is not intended to be exhaustive or to limit the aspects to the precise forms disclosed. Modifications and variations may be made in light of the disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus of a user equipment (UE) for wireless communication, comprising:
a first interface configured to obtain a plurality of reference signal received power (RSRP) measurements, each RSRP measurement of the plurality of RSRP measurements corresponding to an antenna port of a plurality of antenna ports associated with the UE;
a processing system configured to calculate a path loss and a transmit power for the plurality of antenna ports using a worst RSRP measurement of the plurality of RSRP measurements; and
the first interface or a second interface configured to output a sounding reference signal (SRS) using the transmit power.

2. The apparatus of claim 1, wherein the processing system, to calculate the path loss and the transmit power for the plurality of antenna ports, is configured to calculate a common path loss and a common transmit power to be used by each antenna port of the plurality of antenna ports.

3. The apparatus of claim 2, wherein the first interface or the second interface, to output the SRS using the path loss and the transmit power comprises, is configured to:
output a first SRS via a first antenna port of the plurality of antenna ports using the common transmit power; and
output a second SRS via a second antenna port of the plurality of antenna ports using the common transmit power.

4. The apparatus of claim 1, wherein the first interface, to obtain the plurality of RSRP measurements, is configured to calculate the plurality of RSRP measurements based on one or more reference signals received from a network node.

5. The apparatus of claim 1, wherein the plurality of antenna ports includes a primary antenna port and one or more secondary antenna ports, and the worst RSRP measurement corresponds to a secondary antenna port of the one or more secondary antenna ports.

6. The apparatus of claim 1, wherein each RSRP measurement of the plurality of RSRP measurements has a different RSRP measurement value.

7. The apparatus of claim 1, wherein the worst RSRP measurement is a lowest RSRP measurement of the plurality of RSRP measurements.

8. The apparatus of claim 1, wherein the first interface or the second interface, to output the SRS, is configured to output the SRS based on an antenna switching configuration of the UE.

9. The apparatus of claim 1, wherein the plurality of antenna ports is four antenna ports.

10. An apparatus of a user equipment (UE) for wireless communication, comprising:
a first interface configured to obtain a plurality of reference signal received power (RSRP) measurements, each RSRP measurement of the plurality of RSRP measurements corresponding to an antenna port of a plurality of antenna ports associated with the UE;
a processing system configured to calculate a path loss and a transmit power, for each antenna port of the plurality of antenna ports, using an RSRP measurement corresponding to each respective antenna port; and
the first interface or a second interface configured to output a sounding reference signal (SRS) via a select antenna port of the plurality of antenna ports using the transmit power associated with the select antenna port.

11. The apparatus of claim 10, wherein the first interface or the second interface is further configured to output another SRS via another select antenna port of the plurality of antenna ports using the transmit power associated with the other select antenna port.

12. The apparatus of claim 10, wherein the first interface, to obtain the plurality of RSRP measurements, is configured to calculate the plurality of RSRP measurements based on one or more reference signals received from a network node.

13. The apparatus of claim 10, wherein the plurality of antenna ports includes a primary antenna port and one or more secondary antenna ports, and the select antenna port is a secondary antenna port of the one or more secondary antenna ports.

14. The apparatus of claim 10, wherein each RSRP measurement of the plurality of RSRP measurements has a different RSRP measurement value.

15. The apparatus of claim 10, wherein the first interface or the second interface, to output the SRS, is configured to output the SRS based on an antenna switching configuration of the UE.

16. The apparatus of claim 10, wherein the plurality of antenna ports is four antenna ports.

17. A method of wireless communication performed by a user equipment (UE), comprising:
obtaining a plurality of reference signal received power (RSRP) measurements, each RSRP measurement of the plurality of RSRP measurements corresponding to an antenna port of a plurality of antenna ports associated with the UE;
calculating a path loss and a transmit power for the plurality of antenna ports using a worst RSRP measurement of the plurality of RSRP measurements; and
transmitting a sounding reference signal (SRS) using the transmit power.

18. The method of claim 17, wherein calculating the path loss and the transmit power for the plurality of antenna ports comprises calculating a common path loss and a common transmit power to be used by each antenna port of the plurality of antenna ports.

19. The method of claim 18, wherein transmitting the SRS using the path loss and the transmit power comprises:
transmitting a first SRS via a first antenna port of the plurality of antenna ports using the common transmit power; and
transmitting a second SRS via a second antenna port of the plurality of antenna ports using the common transmit power.

20. The method of claim 17, wherein obtaining the plurality of RSRP measurements comprises calculating the plurality of RSRP measurements using one or more reference signals received from a network node.

21. The method of claim 17, wherein the plurality of antenna ports includes a primary antenna port and one or more secondary antenna ports, and the worst RSRP measurement corresponds to a secondary antenna port of the one or more secondary antenna ports.

22. The method of claim 17, wherein each RSRP measurement of the plurality of RSRP measurements has a different RSRP measurement value.

23. The method of claim 17, wherein the worst RSRP measurement is a lowest RSRP measurement of the plurality of RSRP measurements.

24. The method of claim 17, wherein transmitting the SRS comprises transmitting the SRS in accordance with an antenna switching configuration of the UE.

25. A method of wireless communication performed by a user equipment (UE), comprising:
obtaining a plurality of reference signal received power (RSRP) measurements, each RSRP measurement of the plurality of RSRP measurements corresponding to an antenna port of a plurality of antenna ports associated with the UE;
calculating a path loss and a transmit power, for each antenna port of the plurality of antenna ports, using an RSRP measurement corresponding to each respective antenna port; and
transmitting a sounding reference signal (SRS) via a select antenna port of the plurality of antenna ports using the transmit power associated with the select antenna port.

26. The method of claim 25, further comprising transmitting another SRS via another select antenna port of the plurality of antenna ports using the transmit power associated with the other select antenna port.

27. The method of claim 25, wherein obtaining the plurality of RSRP measurements comprises calculating the plurality of RSRP measurements using one or more reference signals received from a network node.

28. The method of claim 25, wherein the plurality of antenna ports includes a primary antenna port and one or more secondary antenna ports, and the select antenna port is a secondary antenna port of the one or more secondary antenna ports.

29. The method of claim 25, wherein each RSRP measurement of the plurality of RSRP measurements has a different RSRP measurement value.

30. The method of claim 25, wherein transmitting the SRS comprises transmitting the SRS in accordance with an antenna switching configuration of the UE.
